(19) United States
(12) Patent Application Publication
(10) Pub. No.: US 2022/0351051 A1
(43) Pub. Date: Nov. 3, 2022

(54) ANALYSIS SYSTEM, APPARATUS, CONTROL METHOD, AND PROGRAM

(71) Applicant: NEC Corporation, Minato-ku, Toko (JP)

(72) Inventor: Norihito GOTO, Toko (JP)

(73) Assignee: NEC Corporation, Minato-ku, Toko (JP)

(21) Appl. No.: 17/634,076

(22) PCT Filed: Oct. 18, 2019
(86) PCT No.: PCT/JP2019/041150

§ 371 Date: Feb. 9, 2022

(30) Foreign Application Priority Data
Aug. 22, 2019 (JP) 2019-152096

(51) Int. Cl. G06N 5/02

(52) U.S. Cl. CPC G06N 5/022

(57) ABSTRACT

Template information (10) includes item definition information (12) determining an item of each piece of input data utilized for generation of a predictive model, algorithm definition information (14) determining a generation algorithm of a predictive model, and view definition information (16) determining a display aspect of information relating to a predictive model. An analysis system (2000) accepts specification of the template information (10). Moreover, the analysis system (2000) accepts, regarding each item determined by the item definition information (12) of the template information (10), specification of input data being associated with the item. Further, the analysis system (2000) processes input data by an algorithm determined by the algorithm definition information (14) of the template information (10), and generates a predictive model. Then, the analysis system (2000) generates display information representing information relating to the predictive model, in a display aspect determined by the view definition information (16) of the template information (10).

### TECHNICAL FIELD

The present invention relates to generation of a predictive model.

### BACKGROUND ART

A technique for analyzing past data, generating a predictive model, and thereby predicting a future demand, abnormality occurrence, or the like has been developed. For example, PTL 1 discloses a technique for predicting, based on an attribute of a user who has made a reservation relating to an area where an enterprise is located, a demand regarding a target that is a target of work of the enterprise and is a target being associated with the attribute of the user.

### RELATED DOCUMENT

### Patent Document

[PTL 1] Japanese Patent Application Publication No. 2019-053737
[PTL 2] Japanese Patent Application Publication No. 2000-285128
[PTL 3] Specification of U.S. Unexamined Patent Application Publication No. 2014/0222741

### Non-Patent Document

[NPL 1] Kenji Fukuda, “How AI Is Transforming Financial Services”, NEC Technical Journal, vol. 69, No. 2, 2016, pp. 16 to 19

### SUMMARY OF THE INVENTION

### Technical Problem

It is not easy to apply prediction by a data analysis to a scene of business. For example, various specific schemes for generating a predictive model exist. Thus, it is necessary to select an appropriate scheme from among the various schemes.

In this respect, PTL 2 discloses a technique for easing an analysis of business data using a template. However, PTL 2 is intended to ease recognition of a past record by statistically analyzing past data, and does not mention performing of prediction. Thus, no technique for easing prediction by a data analysis is disclosed.

The present invention has been made in view of the problem described above, and one object thereof is to provide a technique for easing prediction by a data analysis.

### Solution to Problem

An analysis system according to the present invention includes 1) an input acceptance unit that accepts input specifying one of a plurality of pieces of template information.

The template information includes item definition information determining an item of each piece of input data utilized for generation of a predictive model, algorithm definition information determining a generation algorithm of a predictive model, and view definition information determining a display aspect of information relating to a predictive model.

The analysis system according to the present invention further includes 2) a predictive model generation unit that acquires, regarding each item determined by the item definition information of the specified template information, input data being associated with the item, processes the acquired input data, based on an algorithm determined by the algorithm definition information of the specified template information, and thereby generates a predictive model, and 3) a display information generation unit that generates display information representing information relating to the generated predictive model, in a display aspect determined by the view definition information of the specified template information.

An apparatus according to the present invention includes 1) an input acceptance unit that accepts input specifying one of a plurality of pieces of template information.

The template information includes item definition information determining an item of each piece of input data utilized for generation of a predictive model, algorithm definition information determining a generation algorithm of a predictive model, and view definition information determining a display aspect of information relating to a predictive model.

The input acceptance unit further accepts, regarding each item determined by the item definition information of the specified template information, specification of input data being associated with the item.

The apparatus according to the present invention further includes 2) a display information generation unit that generates display information representing information relating to a predictive model, in a display aspect determined by the view definition information of the specified template information.

The predictive model is generated by processing the specified input data, based on an algorithm determined by the algorithm definition information of the specified template information.

A first control method according to the present invention is executed by a computer. The control method includes 1) an input acceptance step of accepting input specifying one of a plurality of pieces of template information.

The template information includes item definition information determining an item of each piece of input data utilized for generation of a predictive model, algorithm definition information determining a generation algorithm of a predictive model, and view definition information determining a display aspect of information relating to a predictive model.

The control method further includes 2) a predictive model generation step of acquiring, regarding each item determined by the item definition information of the specified template information, input data being associated with the item, processing the acquired input data, based on an algorithm determined by the algorithm definition information of the specified template information, and thereby generating a predictive model, and 3) a display information generation step of generating display information representing information relating to the generated predictive model, in a display aspect determined by the view definition information of the specified template information.

A second control method according to the present invention is executed by a computer. The control method includes 1) an input acceptance step of accepting input specifying one of a plurality of pieces of template information.

The template information includes item definition information determining an item of each piece of input data utilized for generation of a predictive model, algorithm definition information determining a generation algorithm of a predictive model, and view definition information determining a display aspect of information relating to a predictive model.

In the input acceptance step, regarding each item determined by the item definition information of the specified template information, specification of input data being associated with the item is further accepted.

The control method further includes 2) a display information generation step of generating display information representing information relating to a predictive model, in a display aspect determined by the view definition information of the specified template information.

The predictive model is generated by processing the specified input data, based on an algorithm determined by the algorithm definition information of the specified template information.

### Advantageous Effects of Invention

The present invention provides a technique for easing prediction by a data analysis.

### BRIEF DESCRIPTION OF THE DRAWINGS

FIG. 1 is a diagram illustrating an outline of an analysis system according to the present example embodiment.

FIG. 2 is a diagram illustrating a functional configuration of an analysis system according to an example embodiment 1.

FIG. 3 is a diagram illustrating a computer for achieving the analysis system.

FIG. 4 is a diagram illustrating an achievement form of the analysis system.

FIG. 5 is a flowchart illustrating a flow of processing executed by the analysis system according to the example embodiment 1.

FIG. 6 is a diagram illustrating a search screen providing a list of template information.

FIG. 7 is a diagram illustrating a screen specifying association between a sub item in input data and a sub item in item definition information.

FIG. 8 is a diagram illustrating a scatter diagram screen.

FIG. 9 is a diagram illustrating a list screen.

FIG. 10 is a diagram illustrating a scatter diagram screen regarding one prediction target.

FIG. 11 is a diagram illustrating a list screen regarding one prediction target.

FIG. 12 is a diagram illustrating a detail screen.

FIG. 13 is a diagram illustrating template information utilized for prediction of the number of sales.

FIG. 14 is a diagram illustrating template information utilized for prediction of the number of customers.

FIG. 15 is a diagram illustrating template information utilized for prediction of the number of shipments.

FIG. 16 is a diagram illustrating template information utilized for prediction of a received order quantity of a commodity.

FIG. 17 is a diagram illustrating template information utilized for prediction of the number of deliveries of a service part.

FIG. 18 is a diagram illustrating template information utilized for prediction of a failure of equipment.

FIG. 19 is a diagram illustrating template information utilized for determination of a failure state or not.

### DESCRIPTION OF EMBODIMENTS

Hereinafter, an example embodiment of the present invention is described by use of the drawings. Note that, a similar reference sign is assigned to a similar component in all the drawings, and description thereof is omitted accordingly. Further, unless otherwise specially described, each block represents, in each block diagram, not a hardware-based configuration but a function-based configuration.

### Example Embodiment 1

<Outline>

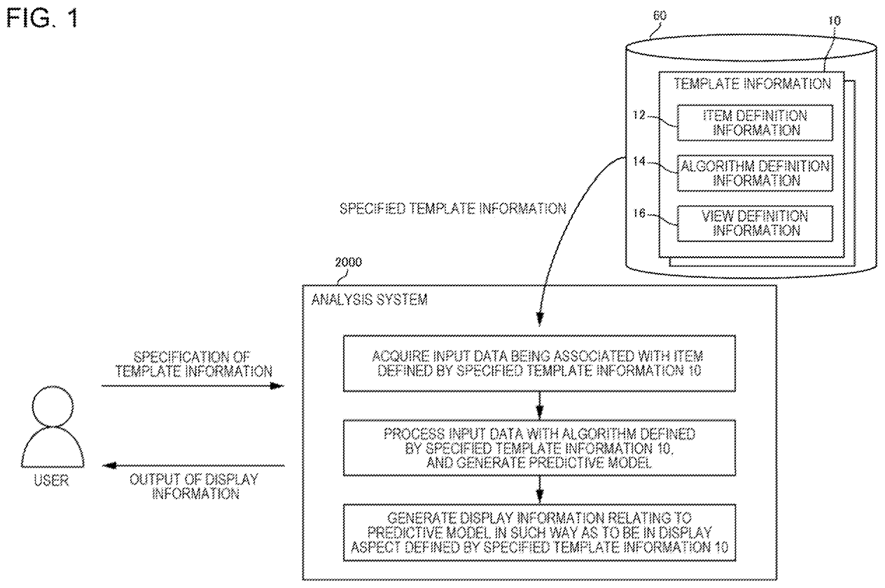

FIG. 1 is a diagram for illustrating an outline of an analysis system 2000 according to the present example embodiment. Note that, FIG. 1 is an exemplification for easing understanding of the analysis system 2000, and a function of the analysis system 2000 is not limited to representation in FIG. 1.

The analysis system 2000 analyzes input data, generates a predictive model, and outputs information relating to the generated predictive model. Herein, a generation method of a predictive model, and in what aspect information is output regarding a generated predictive model are each previously determined as a template. Hereinafter, information representing the template is referred to as template information 10.

The template information 10 includes item definition information 12, algorithm definition information 14, and view definition information 16. The item definition information 12 is information determining an item of each piece of input data utilized for generation of a predictive model. For example, it is assumed that information relating to a product or information relating to a store is utilized for generation of a predictive model predicting sales of a product for each store. In this case, in the template information 10 for generating a predictive model, the item definition information 12 includes an item (a “product master” or the like) equivalent to “information relating to a product”, an item (a “store master” or the like) equivalent to “information relating to a store”, and the like.

The algorithm definition information 14 determines an algorithm for generating a predictive model. For example, it is assumed that a plurality of kinds of AI engines are each prepared as a program module embodying an algorithm for generating a predictive model. In this case, the algorithm definition information 14 indicates information (identification information of an AI engine) determining one of the plurality of kinds of AI engines. However, the algorithm definition information 14 may include not identification information of the AI engine but an AI engine itself. Moreover, an embodiment of an algorithm utilized for generation of a predictive model is not limited to an AI engine.

The view definition information 16 determines a display aspect of information relating to a generated predictive model. For example, the view definition information 16 includes a kind and structure of a diagram utilized for representing information relating to a predictive model, or arrangement or the like of a plurality of diagrams.

In order to achieve generation or the like of a predictive model utilizing the template information 10 described above, the analysis system 2000 first accepts specification of the template information 10. The analysis system 2000 acquires the specified template information 10, and acquires input data being associated with each item determined by the item definition information 12 included in the template information 10. The analysis system 2000 processes the acquired input data, based on an algorithm determined by the algorithm definition information 14 included in the template information 10, and generates a predictive model. Further, the analysis system 2000 generates display information by utilizing the view definition information 16 included in the template information 10. The display information represents information relating to a predictive model, in a display aspect determined by the view definition information 16.

### One Example of Advantageous Effect

It is not easy to apply prediction by a data analysis to a scene of business. For example, it is difficult to appropriately select a generation algorithm of a predictive model. Moreover, it is also difficult to recognize what data are necessary for generation of a predictive model. Furthermore, an appropriate way of viewing a prediction result is also difficult to recognize.

In this respect, the analysis system 2000 according to the present example embodiment provides the template information 10 including, as a set, the item definition information 12 defining an item of input data utilized for generation of a predictive model, the algorithm definition information 14 defining an algorithm utilized for generating the predictive model, and the view definition information 16 defining a way of viewing an analysis result, and generation of a predictive model and browsing of an analysis result are performed by utilizing the template information 10. Thus, a user can easily perform a data analysis related to his/her business, by specifying the template information 10 being associated with the business. Therefore, the present invention allows prediction utilizing a data analysis to be easily performed.

Herein, choosing or the like of an algorithm suited to business is generally performed by a professional of a data analysis called a data scientist. However, since the number of data scientists is limited, there is a problem that a time required for a data analysis becomes long or cost becomes high when a data scientist is asked for each data analysis.

In this respect, when the present invention is utilized, for example, a data scientist previously generates the template information 10 suited to each business, and thereby allows knowledge of the data scientist to be easily expanded to a person at a business scene. Thus, a reduction of a time or cost required for a data analysis can be achieved. Moreover, since knowledge of a data scientist can be put into a form of the template information 10, it becomes unnecessary for a data scientist to individually deal with similar business, and there is also an advantage that business of a data scientist can be increased in efficiency.

The present example embodiment is described below in further detail.

<Example of Functional Configuration>

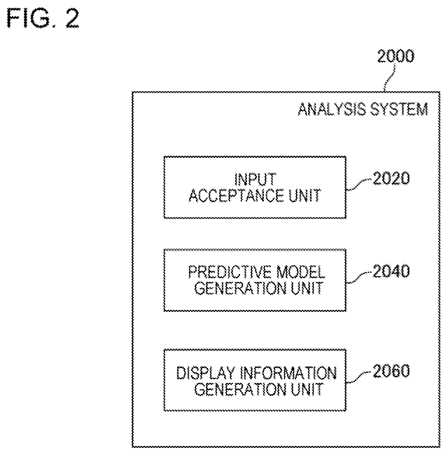

FIG. 2 is a diagram illustrating a functional configuration of the analysis system 2000 according to the example embodiment 1. The analysis system 2000 includes an input acceptance unit 2020, a predictive model generation unit 2040, and a display information generation unit 2060. The input acceptance unit 2020 accepts specification of the template information 10. The predictive model generation unit 2040 acquires, regarding each item determined by the item definition information 12 of the specified template information 10, input data being associated with the item. Moreover, the predictive model generation unit 2040 processes the acquired input data, based on an algorithm determined by the algorithm definition information 14 of the specified template information 10, and thereby generates a predictive model. The display information generation unit 2060 generates display information by utilizing the view definition information 16.

<Example of Hardware Configuration of Analysis System 2000>

Each function-configuring unit of the analysis system 2000 may be achieved by hardware (example: a hard-wired electronic circuit, or the like) that achieves each function-configuring unit, or may be achieved by a combination of hardware and software (example: a combination of an electronic circuit and a program controlling the electronic circuit, or the like). A case where each function-configuring unit of the analysis system 2000 is achieved by a combination of hardware and software is further described below.

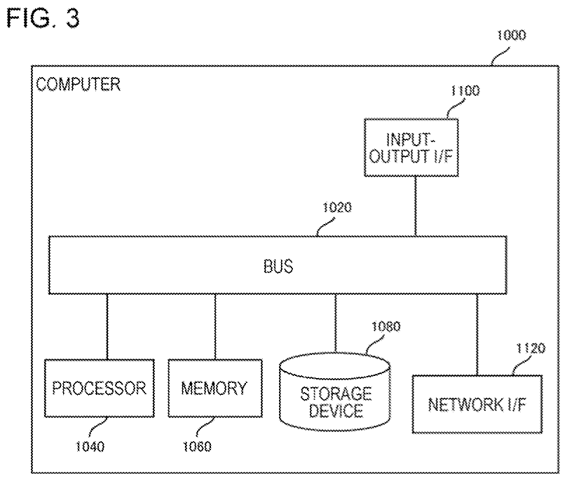

The analysis system 2000 is achieved by use of one or more computers. FIG. 3 is a diagram illustrating a computer 1000 for achieving the analysis system 2000. The computer 1000 is any computer. For example, the computer 1000 is a stationary computer such as a personal computer (PC) or a server machine. Additionally, for example, the computer 1000 is a portable computer such as a smartphone or a tablet terminal.

The computer 1000 may be a dedicated computer designed to achieve the analysis system 2000, or may be a general-purpose computer. In the latter case, at least some of functions of the analysis system 2000 are achieved in the computer 1000, for example, by installing a predetermined application in the computer 1000. The application described above is an application configured by a program for achieving any one or more of the function-configuring units of the analysis system 2000.

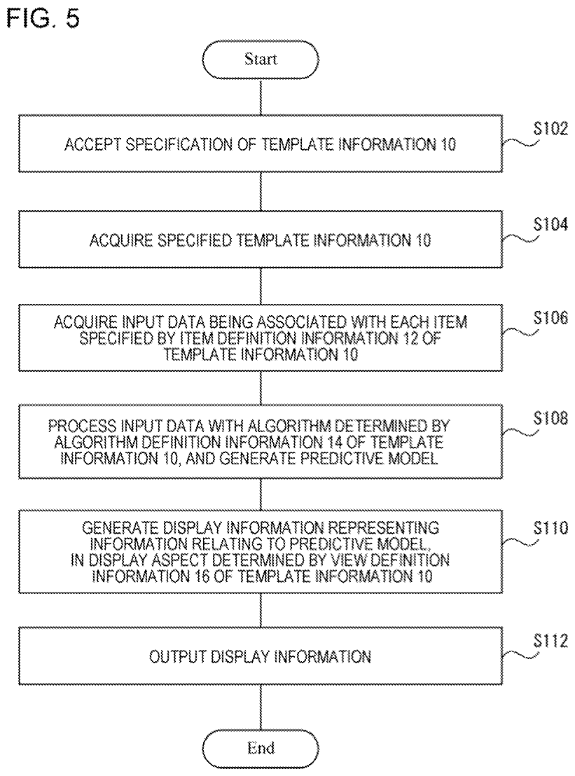

For example, as described later, the analysis system 2000 is configurable by a back-end server 40 that performs generation of a predictive model, and a front-end server 30 that functions as an interface between a user terminal 20 and the back-end server 40 (see FIG. 5). In this case, the front-end server 30 and the back-end server 40 are achieved by the computers 1000 differing from each other. In this case, an application for achieving a function given to the front-end server 30 among functions of the analysis system 2000 is installed in the computer 1000 that achieves the front-end server 30. On the other hand, an application for achieving a function given to the back-end server 40 among functions of the analysis system 2000 is installed in the computer 1000 that achieves the back-end server 40.

The computer 1000 includes a bus 1020, a processor 1040, a memory 1060, a storage device 1080, an input-output interface 1100, and a network interface 1120. The bus 1020 is a data transmission path through which the processor 1040, the memory 1060, the storage device 1080, the input-output interface 1100, and the network interface 1120 transmit/receive data to/from one another. However, a method of mutually connecting the processor 1040 and the like is not limited to bus connection.

The processor 1040 is various processors such as a central processing unit (CPU), a graphics processing unit (GPU), and a field-programmable gate array (FPGA). The memory 1060 is a main storage apparatus achieved by use of a random access memory (RAM) or the like. The storage device 1080 is an auxiliary storage apparatus achieved by use of a hard disk, a solid state drive (SSD), a memory card, a read only memory (ROM), or the like.

The input-output interface 1100 is an interface for connecting the computer 1000 and an input-output device. For example, an input apparatus such as a keyboard and an output apparatus such as a display apparatus are connected to the input-output interface 1100.

The network interface 1120 is an interface for connecting the computer 1000 to a communication network. The communication network is, for example, a local area network (LAN) or a wide area network (WAN). For example, an analysis apparatus and a user terminal are communicably connected via the network interface 1120.

The storage device 1080 stores a program module that achieves each of function-configuring units of the analysis system 2000 (a program module that achieves the application described above). The processor 1040 reads each of the program modules onto the memory 1060, executes the read program module, and thereby achieves a function being associated with each of the program modules.

<Example of Achievement Form of Analysis System 2000>

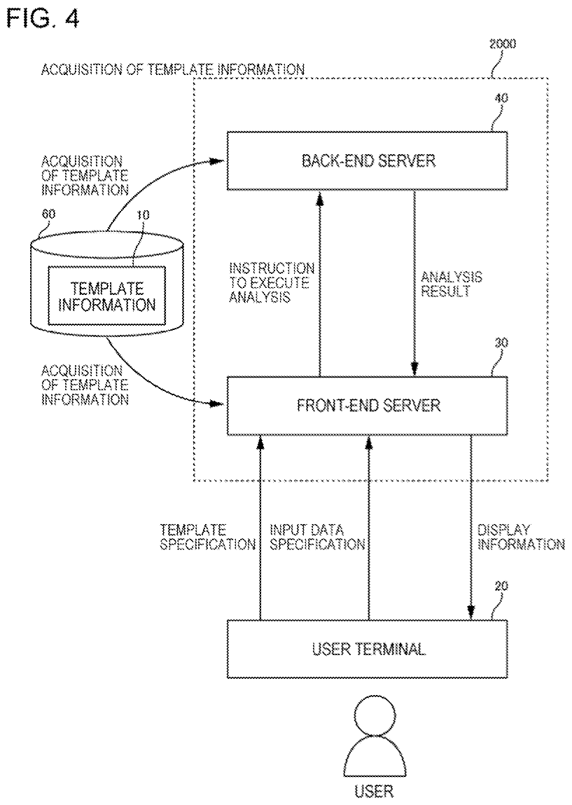

As described above, the analysis system 2000 is achieved by use of one or more computers. FIG. 4 is a diagram illustrating an achievement form of the analysis system 2000.

In FIG. 4, the analysis system 2000 is configured by the front-end server 30 and the back-end server 40. For example, the front-end server 30 provides a user with a website for utilizing the analysis system 2000. A user who desires to utilize the analysis system 2000 first accesses the front-end server 30 by utilizing the user terminal 20. The front-end server 30 provides the user terminal 20 with a web page for specifying the template information 10 and input data. A user performs specification of the template information 10 and input data by utilizing the provided web page in the user terminal 20.

The front-end server 30 causes the back-end server 40 to execute an analysis by utilizing the specified template information 10 and input data. For example, the front-end server 30 causes the back-end server 40 to execute an analysis, by transmitting, to the back-end server 40, a predetermined command including information received from the user terminal 20, such as identification information of the template information 10. The back-end server 40 generates a predictive model by executing an analysis in response to the instruction.

The back-end server 40 transmits information representing an analysis result (information relating to the predictive model) to the front-end server 30. The front-end server 30 processes the information received from the back-end server 40 by utilizing the view definition information 16 of the template information 10, and thereby generates display information. Then, the front-end server 30 outputs the display information to a user terminal. For example, the display information is a web page in which information relating to a predictive model can be browsed in a display aspect defined by the view definition information 16 of the template information 10. Additionally, for example, the display information may be provided as a file such as a PDF file.

An achievement form of the analysis system 2000 is not limited to the example described above. For example, the front-end server 30 and the back-end server 40 may be achieved by one computer. Additionally, for example, a function equivalent to the front-end server 30 may be given to the user terminal 20. In other words, the user terminal 20 is given a function of accepting specification of the template information 10 and input data, a function of instructing the back-end server 40 to execute an analysis, a function of receiving an analysis result from the back-end server 40, and a function of generating display information from a received analysis result (i.e., an application that achieves a function of interacting with the back-end server 40 is installed in the user terminal). Additionally, for example, the user terminal 20 may be given both functions of the front-end server 30 and the back-end server 40. Specifically, the analysis system 2000 is achieved by a computer operated by a user (an application that achieves all functions of the analysis system 2000 is installed in the user terminal 20).

<Flow of Processing>

FIG. 5 is a flowchart illustrating a flow of processing executed by the analysis system 2000 according to the example embodiment 1. The input acceptance unit 2020 accepts specification of the template information 10 (S102). The predictive model generation unit 2040 acquires the specified template information 10 (S104). The predictive model generation unit 2040 acquires, regarding each item determined by the item definition information 12 included in the acquired template information 10, input data being associated with the item (S106). The predictive model generation unit 2040 analyzes the acquired input data, based on an algorithm determined by the algorithm definition information 14 included in the acquired template information 10, and thereby generates a predictive model (S108). The display information generation unit 2060 generates display information regarding the generated predictive model (S110). The display information generation unit 2060 outputs display information (S112).

<Specification and Acquisition of Template Information 10: S102, S104>

The input acceptance unit 2020 accepts specification of the template information 10 (S102). For example, the input acceptance unit 2020 provides a user with a list of the utilizable template information 10, and causes the user to specify (select) the template information 10.

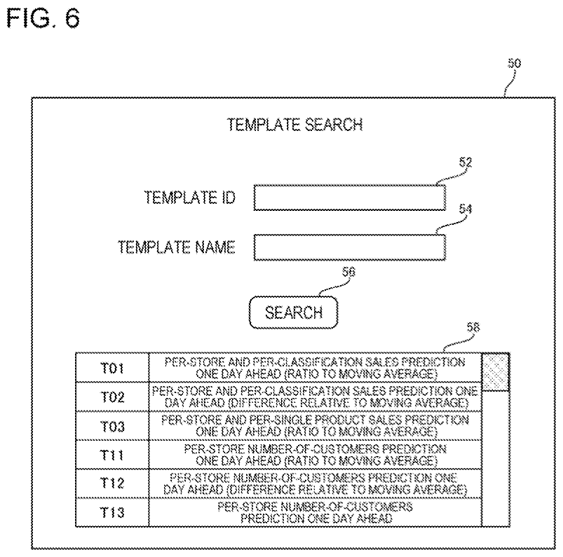

FIG. 6 is a diagram illustrating a search screen 50 providing a list of the template information 10. The search screen 50 is displayed on a display apparatus being capable of controlling from the user terminal 20. For example, the search screen 50 is achieved by a web page provided by the front-end server 30 described above.

The search screen 50 includes an identification information specification area 52, a name specification area 54, a search button 56, and a search result display area 58. When the search button 56 is pressed in a state where nothing is input to the identification information specification area 52 and the name specification area 54, information regarding all pieces of the template information 10 stored in a template storage apparatus 60 is displayed in the search result display area 58. On the other hand, when the search button 56 is pressed in a state where input is performed to the identification information specification area 52, information regarding only the template information 10 whose identification information includes a character string input to the identification information specification area 52 is displayed in the search result display area 58. Moreover, when the search button 56 is pressed in a state where input is performed to the name specification area 54, information regarding only the template information 10 whose name includes a character string input to the name specification area 54 is displayed in the search result display area 58.

Note that, a search of the template information 10 is not limited to a search using identification information or a name. For example, the template information 10 includes information representing an industry in which the template may be utilized, or a solution or the like provided by use of the template. An industry includes, for example, retail, manufacture, physical distribution, insurance, finance, or the like. A solution includes, for example, demand forecasting, abnormality sensing, or the like. When the pieces of information are utilized, an input area in which an industry or a solution is specified is provided in the search screen 50. Then, the input acceptance unit 2020 searches for the template information 10 with the specified industry or the specified solution, and displays information regarding the template information 10 in the search result display area 58. This allows the template information 10 to be easily selected according to an industry or a solution.

Additionally, for example, the input acceptance unit 2020 may provide a function of searching for the template information 10 utilized by the same user in the past. Consequently, a user can easily again utilize the template information 10 utilized in the past.

The predictive model generation unit 2040 acquires the specified template information 10 (S104). Herein, an existing technique can be utilized for a specific technique for acquiring the specified template information 10. For example, the predictive model generation unit 2040 acquires the specified template information 10 by reading from the template storage apparatus 60.

<Acquisition of Input Data: S106>

The predictive model generation unit 2040 acquires input data being associated with an item determined by the item definition information 12 (S106). The item definition information 12 includes information representing an item of input data utilized for generation of a predictive model. An item of input data can also be referred to as a class of input data. For example, as an item, various items can be adopted, such as a calendar, a product master, a store master, weather data, sales data, or data on the number of customers. For example, when the template information 10 includes an item referred to as a customer master, the predictive model generation unit 2040 acquires specific data representing the customer master (a file, a table on a database, or the like recording information regarding a customer).

For example, acquisition of input data is achieved by accepting, from a user, specification of input data being associated with an item determined by the item definition information 12. For example, for each item determined by the item definition information 12, a user provides the predictive model generation unit 2040 with an input file storing input data regarding the item. Provision of an input file is achieved, for example, by transmitting an input file from the user terminal 20 to the front-end server 30. Additionally, for example, an input file may be previously stored in a storage apparatus accessible from the front-end server 30, and specification of identification information (a path or the like) of the input file may be performed from the user terminal 20 to the front-end server 30.

A provision method of input data is not limited to a method of utilizing a file. For example, it is assumed that data stored in a database are utilized as input data. In this case, for example, a user may specify, for each item determined by the item definition information 12, data (e.g., a table) in a database storing data regarding the item. The predictive model generation unit 2040 acquires input data from a database according to specification by a user.

Herein, data being associated with one item may be divided into further detailed items. For example, data of an item referred to as a product master may include a plurality of kinds of data such as a product code and a product name for each product. Hereinafter, when one item is associated with a plurality of further detailed items, the former item is referred to as a major item, and each of the latter items is referred to as a sub item. When a plurality of sub items are associated with a major item in this way, association between the major item and the sub item is further defined in the item definition information 12.

When a plurality of sub items are associated with a major item, it is necessary that, in order for the predictive model generation unit 2040 to correctly interpret input data acquired by being associated with the major item, the predictive model generation unit 2040 can interpret the input data separately for each of the sub items. To do so, for example, input data are configured in a format distinguishable for each sub item defined by the item definition information 12. For example, a csv format can be handled as a data format in which input data are distinguishable for each sub item. Generally, a csv file can include definition of a column name of each column, and one or more records having data for each column. Accordingly, input data can be interpreted separately for each sub item by configuring input data in such a way that each column represents one sub item. However, a format of an input file does not necessarily need to be in a csv format. Moreover, input data being associated with one major item may be a table on a database, and each column of the table may be handled as a sub item.

It is necessary that the predictive model generation unit 2040 can determine an association relation between a sub item in the item definition information 12 and a sub item in input data. Accordingly, for example, a name of each sub item in input data is previously matched with a name of each sub item in the item definition information 12. Consequently, the predictive model generation unit 2040 can interpret input data being associated with a major item for each sub item being associated with the major item.

However, a name of each sub item in input data may not match a name of each sub item in the item definition information 12. In this case, for example, the input acceptance unit 2020 accepts input specifying association between a sub item in input data and a sub item in the item definition information 12. The predictive model generation unit 2040 interprets input data by use of specified association.

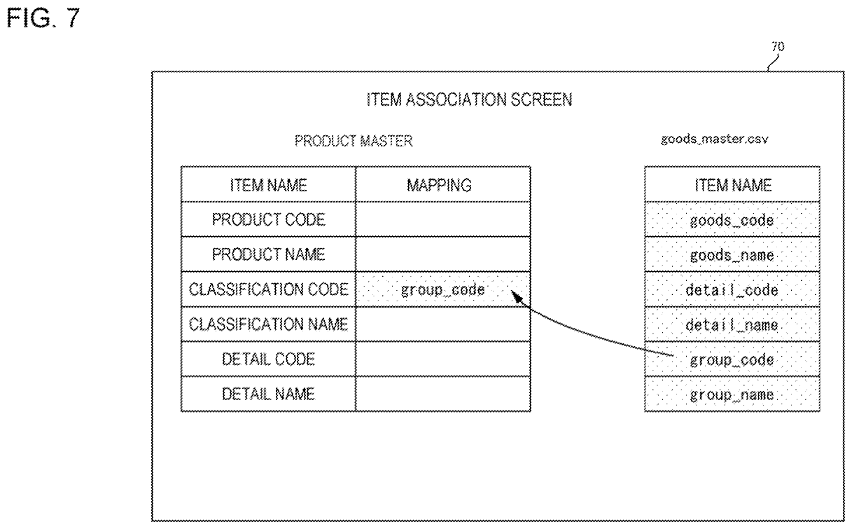

FIG. 7 is a diagram illustrating a screen 70 specifying association between a sub item in input data and a sub item in the item definition information 12. In the screen 70, a table in a left side indicates a list of sub items being associated with a major item referred to as a product master in the item definition information 12. On the other hand, a table in a right side indicates a list of sub items in a file referred to as goods_master.csv supplied as input data being associated with a major item referred to as a product master. Note that, when a table of a database is specified instead of a file herein, the table in the right side displays a column name of each column of the specified table.

In the screen 70, a user can drag and drop each sub item indicated by the table in the right side to a cell of a column referred to as a mapping in the left side. This achieves association of a sub item. For example, in this example, a user drags and drops a sub item referred to as “group_code” in the table in the right side to a cell next to a sub item referred to as “classification code” in the table in the left side. This associates the sub item referred to as “classification code” in the item definition information 12 with the sub item referred to as “group_code” in the input file.

Note that, when a name of a sub item in the item definition information 12 does not match a name of a sub item in input data, a method of determining an association relation between a sub item in the item definition information 12 and a sub item in input data is not limited to a method that accepts specification by a user. For example, the association relation may be determined by an order of sub items. For example, a rule “an order of sub items in the item definition information 12 matches an order of sub items in input data” is previously determined. By utilizing the rule, the predictive model generation unit 2040 can recognize an association relation between a sub item in the item definition information 12 and a sub item in input data.

<Generation of Predictive Model: S108>

The predictive model generation unit 2040 processes input data, based on an algorithm determined by the algorithm definition information 14, and thereby generates a predictive model. For example, various machine learning algorithms such as heterogeneous mixture learning (PTL 3), a RAPID time-series analysis (NPL 1), a neural network, or a support vector machine (SVM) can be each handled as an algorithm that generates a predictive model.

For example, the predictive model generation unit 2040 is provided with, for each of various machine learning algorithms, an AI engine being a program module that achieves the algorithm. In this case, for example, the algorithm definition information 14 includes identification information determining one of the plurality of AI engines. The predictive model generation unit 2040 performs generation of a predictive model by utilizing an AI engine determined by identification information included in the algorithm definition information 14.

Herein, there is a case where the same AI engine can be utilized by a plurality of analysis types (regression, determination, and the like). In this case, information indicating a type of analysis desired to be performed (a type of predictive model desired to be generated) is further included in the algorithm definition information 14. For example, the template information 10 for generating, by heterogeneous mixture learning, a predictive model that predicts sales of a product includes “AI engine: heterogeneous mixture learning, analysis type: regression”. On the other hand, the template information 10 for generating, by heterogeneous mixture learning, a predictive model that predicts whether equipment fails in the future includes “AI engine: heterogeneous mixture learning, analysis type: determination”.

Moreover, information representing association between an objective variable or an explanatory variable of an AI engine and input data is also included in the algorithm definition information 14. For example, which sub item to use as an objective variable and which sub item to use as an explanatory variable among sub items determined by the item definition information 12 are determined in the algorithm definition information 14. However, an objective variable or an explanatory variable may have some relation with one or more sub items determined by the item definition information 12, and does not need to fully match a sub item. For example, in prediction of the number of sales of a product, the number of sales of a product can be included in sales record data (“number of sales” can be included in a sub item being associated with a major item referred to as sales record data), and an objective variable can be “a difference from a moving average of the number of sales”.

Moreover, a hyperparameter to be set in an AI engine may be further determined in the algorithm definition information 14. As a hyperparameter, depth of a tree in heterogeneous mixture learning, depth of a layer in a neural network, or the like can be cited.

Further, information determining preprocessing to which input data are subjected before being put into an AI engine may be determined in the predictive model generation unit 2040. When a predictive model is generated by an AI engine, learning accuracy can be improved by not using input data without change but performing scale conversion or the like. Accordingly, in the item definition information 12, such preprocessing to be added to input data is defined. Additionally, for example, processing or the like of extracting only a part of input data as a processing target is also defined as preprocessing. Additionally, for example, processing of converting a format of input data into a predetermined format (format interpretable by an AI engine) determined for each AI engine is also defined as preprocessing.

Note that, the algorithm definition information 14 may include a program module itself that achieves preprocessing, or may include identification information (a function name or the like) or setting information (an argument or the like) for calling a program that achieves preprocessing. In the latter case, various pieces of preprocessing are previously provided in the predictive model generation unit 2040. Then, in the algorithm definition information 14, identification information of preprocessing desired to be utilized and setting information of the preprocessing are determined, and thereby desired preprocessing is executed by the predictive model generation unit 2040.

Herein, a predictive model (a target of prediction) generated by an analysis utilizing one piece of the template information 10 is not limited to one. For example, it is assumed that the template information 10 for predicting the number of sales for each store and for each product is prepared. In this case, a target of prediction is the number of sales for each combination of “a store and a product”. Thus, when the template information 10 is utilized, predictive models for each store and for each product are generated.

For example, as a simple example, it is assumed that there are three kinds of products being products G1 to G3, and there are two stores being stores S1 and S2. In this case, since there are six prediction targets, six predictive models are generated. Specifically, a predictive model of the number of sales for each of the products G1 to G3 is generated for each of the stores S1 and S2.

What predictive model is generated by an analysis utilizing one piece of the template information 10 is previously defined by the algorithm definition information 14. In other words, an objective variable is previously defined in a form such as “sales for each store and for each product”, in the template information 10 for generating predictive models that predict the numbers of sales for each store and for each product. Thus, predictive models are generated for each store and for each product by the predictive model generation unit 2040.

Herein, it is preferred that the predictive model generation unit 2040 performs not only generation of a predictive model but also evaluation (verification) of accuracy thereof. In this case, for example, the predictive model generation unit 2040 divides input data into data for learning and verification data. Then, the predictive model generation unit 2040 performs generation of a predictive model (learning of a model) by utilizing the data for learning, and performs verification of the predictive model by utilizing the verification data. Additionally, for example, the predictive model generation unit 2040 may perform so-called cross-validation. An existing technique can be utilized for a specific method of dividing input data and performing generation and evaluation of a model in this way.

Further, the predictive model generation unit 2040 may execute prediction utilizing a predictive model, in addition to generation and verification of a predictive model. In this case, for example, the predictive model generation unit 2040 divides input data into test data utilized for prediction, and other data (data utilized for learning and verification). Then, after performing generation and verification of the predictive model with the latter, the predictive model generation unit 2040 executes prediction by utilizing the test data. Note that, an existing technique can be utilized for a specific method of dividing input and performing generation, verification, and prediction of a predictive model in this way.

However, the analysis system 2000 does not necessarily need to generate a predictive model and then immediately execute prediction. For example, a user first performs generation and verification of a predictive model by utilizing the analysis system 2000. The generated predictive model is stored in a storage apparatus accessible from the analysis system 2000. Thereafter, when a need for prediction arises, a user performs prediction by utilizing the previously generated predictive model.

Herein, a division method of input data may be fixedly determined regardless of the template information 10, may be determined by the template information 10, or may be specified by a user. For example, when input data are divided in a period, a user specifies a period of input data to be utilized, regarding each of data for learning, verification data, and test data.

Note that, prediction utilizing a predictive model does not necessarily need to be executed by the analysis system 2000. For example, when the analysis system 2000 is configured by the front-end server 30 and the back-end server 40 as described above, prediction utilizing a predictive model may be executed in the user terminal 20. In this case, a predictive model generated by the analysis system 2000 is stored in a storage apparatus accessible from the user terminal 20.

<Generation of Display Information: S110>

The display information generation unit 2060 generates, in a display aspect defined by the view definition information 16 of the specified template information 10, display information regarding a predictive model generated by the predictive model generation unit 2040 (S110). For example, information relating to a predictive model is displayed by using a diagram being easy to recognize visually. Thus, the view definition information 16 includes definition of a kind, a structure, or the like, regarding each of one or more diagrams included in the display information. Any kind such as a table, a scatter diagram, a line graph, or a bar graph can be adopted as a kind of diagram. A structure of a table includes, for example, definition of each column. A structure of a graph includes, for example, definition of each axis. Moreover, the view definition information 16 further includes information determining overall arrangement of a plurality of diagrams and other information.

While exemplifying a screen generatable as display information by the display information generation unit 2060, the view definition information 16 being associated with such a screen is described below.

For example, display information is configured by a scatter diagram screen displaying a scatter diagram, a list screen displaying a list, and a detail screen displaying detailed information. The screens are configured in such a way as to allow movement to and from one another. In an example described below, a predictive model (regression model) that predicts the number of sales for each of the product classifications G1 to G3 is generated for each of the stores S1 to S3. In other words, the number of sales for each combination of “a store and a product classification” is a prediction target. Moreover, cross-validation is used for generation of a predictive model. Thus, a plurality of predictive models are generated for each prediction target. For example, it is assumed that, among pieces of input data, input data used for learning and verification are divided into five periods. In this case, five predictive models are generated for each prediction target.

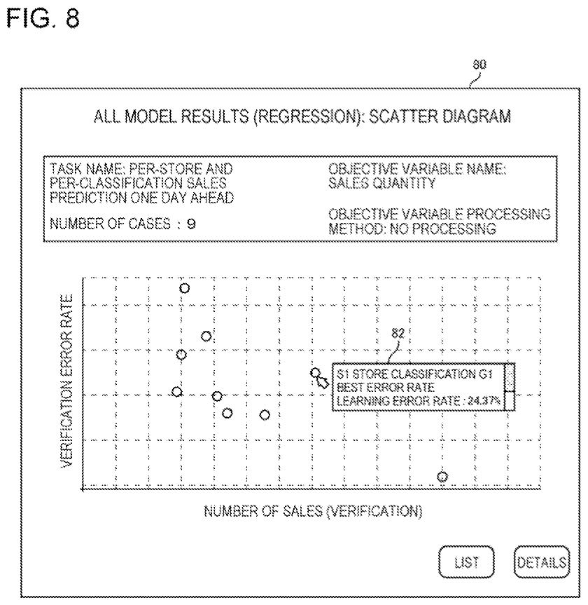

FIG. 8 is a diagram illustrating a scatter diagram screen 80. A horizontal axis of a scatter diagram is the number of sales indicated by input data for verification. A vertical axis of the scatter diagram indicates a verification error rate (an error rate in verification of a predictive model). Note that, an error rate referred to herein is a value representing a deviation degree between a predictive value output by a predictive model and a record value indicated in input data. Specifically, an error rate is a value derived by dividing an average of an absolute value of a difference between a record value and a predictive value by an average of an absolute value of a record value.

In the scatter diagram, a data point is plotted for each prediction target (each combination of a store and a product classification) regarding one representative predictive model. The representative predictive model is the best predictive model selected by the display information generation unit 2060, based on a predetermined criterion. As such a criterion, a criterion relating to magnitude of an error, a criterion relating to magnitude of an influence degree of an explanatory variable on an objective variable, or the like can be adopted.

A criterion of selecting the best predictive model is determined in, for example, the view definition information 16. However, a criterion of selecting the best predictive model may be specifiable by a user operation. Moreover, a representative predictive model itself may also be specifiable by a user operation.

In FIG. 8, when a user selects (e.g., clicks) a data point, details of a predictive model being associated with the data point are displayed (a pop-up window 82). Specifically, information such as identification information of a prediction target, identification information of the best predictive model, a selection criterion of the best predictive model, and an evaluation index (an error rate or the like) of each section (a learning section, a verification section, and a prediction section) is displayed.

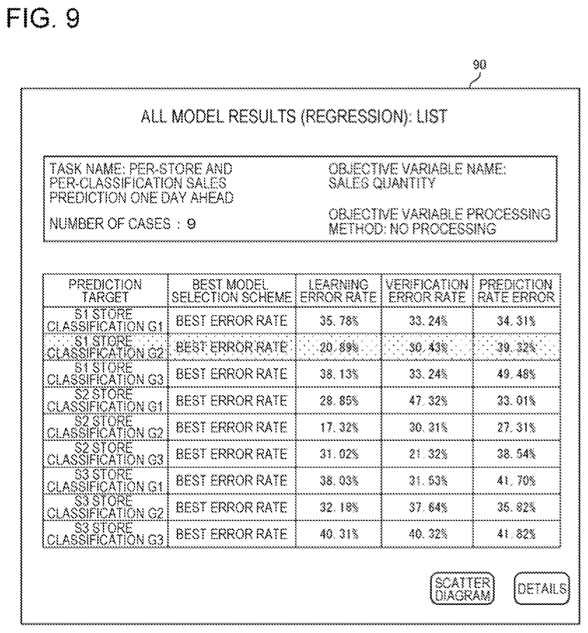

FIG. 9 is a diagram illustrating a list screen. A user can perform transition on a screen to a list screen 90 by pressing a list button in the scatter diagram screen 80 or a detail screen 130 described later. A list included in the list screen 90 indicates information relating to a representative predictive model for each prediction target.

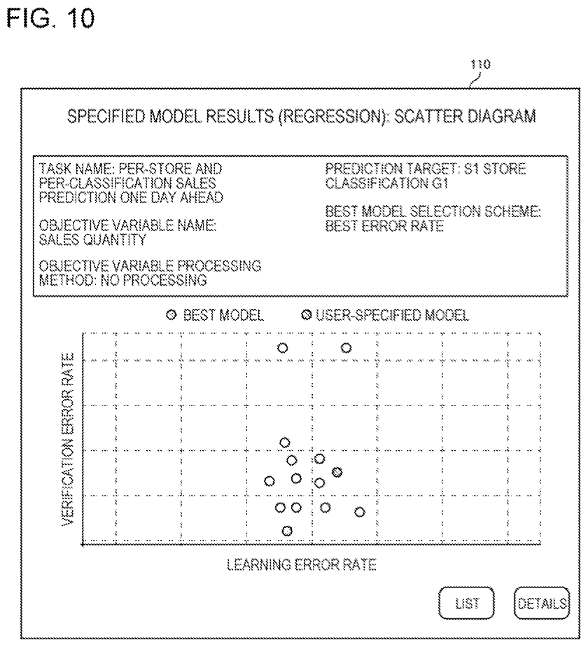

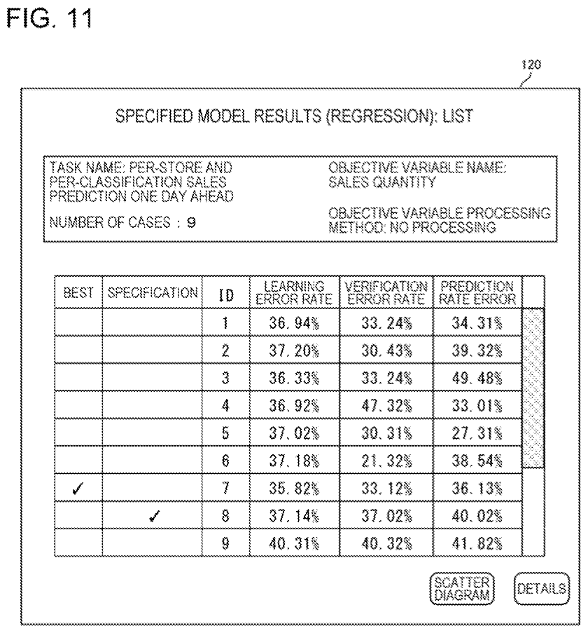

Herein, one prediction target may be selected in the scatter diagram screen 80 or the list screen 90 in such a way that a transition can be made to a screen in which information of all predictive models generated regarding the prediction target can be browsed. Description is given below by use of FIGS. 10 and 11.

FIG. 10 is a diagram illustrating a scatter diagram screen 110 regarding one prediction target. In the scatter diagram, a data point is plotted regarding each of a plurality of predictive models generated regarding one prediction target “store S1 and product classification G1”. A horizontal axis indicates a learning error rate (an error rate at learning end), and a vertical axis is a verification error rate. In this diagram as well, a user selects a data point, and thereby, details of a predictive model being associated with the data point are displayed.

Note that, the scatter diagram in FIG. 10, data points regarding the best predictive model automatically selected based on a predetermined criterion, and a predictive model specified by a user are highlighted (filled) in such a way that each of the predictive models can be discriminated from other predictive models.

FIG. 11 is a diagram illustrating a list screen 120 regarding one prediction target. A list included in the list screen 120 lists information relating to a plurality of predictive models generated regarding one prediction target.

Note that, as in the screen illustrated in FIGS. 8 and 9, a screen indicating information regarding each of a plurality of models is generated only when there are a plurality of predictive models. Thus, in this case, a screen focusing one predictive model is displayed as an initial screen, as in the screen illustrated in FIGS. 10 and 11.

As described above, display information may also include a detail screen. The detail screen is a screen indicating detailed information, regarding one selected prediction target. A transition to the detail screen can be achieved, for example, by pressing a detail button in a state where one prediction target is selected in the scatter diagram screen 80 or the list screen 90 displaying information regarding all prediction targets. Additionally, for example, a transition to the detail screen can be achieved by pressing a detail button in the scatter diagram screen 110 or the list screen 120 displaying information regarding a selected prediction target.

The detail screen may include various pieces of information such as information relating to an evaluation index, information relating to an explanatory variable, a graph relating to an error, information relating to a configuration of a predictive model, and information relating to a hyperparameter. A configuration included in the detail screen may vary depending on a kind of AI engine utilized for generation of a predictive model, or the like.

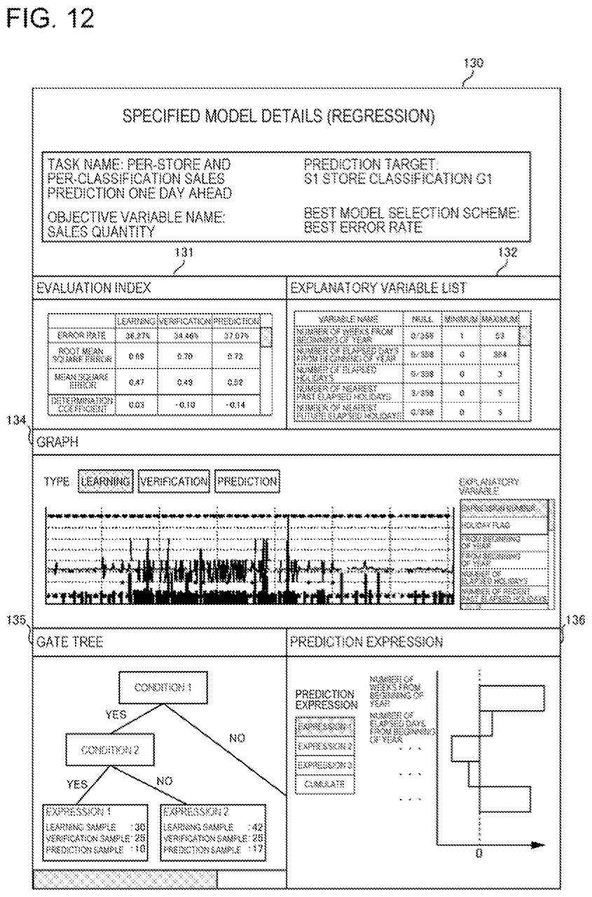

FIG. 12 is a diagram illustrating a detail screen. This example is a case where heterogeneous mixture learning is utilized as an AI engine. The detail screen 130 in FIG. 12 includes an evaluation index area 131, an explanatory variable list area 132, a graph area 134, a gate tree area 135, and a prediction expression area 136.

In the evaluation index area 131, information relating to an evaluation index is listed. Specifically, regarding each evaluation index, a value of an evaluation index computed regarding each of a learning time (model generation time), a verification time, and a prediction execution time is indicated. As an evaluation index, various evaluation indices such as an error rate, a root mean square error (RMSE), or a mean square error (MSE) can be utilized.

In the explanatory variable list area 132, information relating to each explanatory variable is listed. Herein, “NULL” indicates in how many records of input including data being associated with the explanatory variable data thereof lack. For example, NULL being 3/358 in an explanatory variable “number of nearest past elapsed holidays” indicates that data for the number of nearest past elapsed holidays lack in three records among 358 records. A minimum and a maximum indicate a minimum value and a maximum value in input data regarding the explanatory variable.

Note that, an explanatory variable may indicate a category value such as a day of a week or weather. In this case, a category value included in at least one record is enumerated instead of a minimum and a maximum. For example, it is assumed that, regarding an explanatory variable indicating a day of a week as a value, five kinds of values “Monday, Tuesday, Thursday, Saturday, and Sunday” are indicated in 100 input records, and “Wednesday and Friday” are not indicated in any of the records. In this case, in the explanatory variable list area 132, five category values “Monday, Tuesday, Thursday, Saturday, and Sunday” are indicated instead of a minimum and a maximum regarding the explanatory variable.

A graph representing information regarding a predictive model is displayed in the graph area 134. A horizontal axis represents time. A time change of a predictive value (output of a predictive model) at a learning time, a time change of a record value (a value of input data), and a time change of an error are indicated in the graph area 134 in FIG. 12. Moreover, since an “expression number” is selected, a time change of an expression number utilized for prediction (a time change of a prediction expression matching a condition) is also indicated.

An overall structure of a predictive model generated by heterogeneous mixture learning is indicated in the gate tree area 135. A predictive model generated by heterogeneous mixture learning has a tree structure (gate tree) representing conditional branching, and has a prediction expression in each leaf. Thus, a gate tree, and the number of samples (the number of records included in input data) regarding a prediction expression in each leaf are indicated in the gate tree area 135. Note that, although a condition indicated in a node of a gate tree is described as a “condition 1” or the like in FIG. 12 for a reason of illustration, a specific conditional expression is actually described in a node.

The prediction expression area 136 indicates a coefficient of each explanatory variable regarding a selected prediction expression. Moreover, when “cumulate” is selected, a value in which a coefficient of each explanatory variable is summed regarding all prediction expressions is displayed.

As described above, the detail screen 130 in FIG. 12 is a screen suited to a case where heterogeneous mixture learning is utilized as an AI engine. At least some areas become differing areas when another AI engine is utilized. For example, in a case of a RAPID time-series analysis, it is preferred to include, in a detail screen, a graph indicating convergence status of learning or information relating to a hyperparameter, instead of a gate tree area or a prediction expression area. Note that, it is preferred that the information relating to a hyperparameter is included in a detail screen in a case where another AI engine is utilized as well, including heterogeneous mixture learning.

In the example described above, a regression model is generated as a predictive model. In this respect, information to be provided regarding a determination model may differ from information to be provided regarding a regression model. For example, an evaluation index of a determination model may differ from an evaluation index of a regression model. Thus, when a determination model is generated, an evaluation index of the determination model is displayed in each of the screens described above. For example, as an evaluation index of the determination model, precision (true positive/{true positive+false positive}), recall (true positive/{true positive+false negative}), an F-value (a harmonic average of precision and recall), or the like can be adopted.

Herein, each of the screens described above includes much of information relating to accuracy of a predictive model, and is a screen particularly preferred for confirmation of accuracy of a predictive model. However, an analysis result (i.e., display information) provided by the analysis system 2000 is not limited to an analysis result particularly preferred for confirmation of accuracy of a predictive model, and may be an analysis result particularly preferred for another purpose.

For example, information particularly preferred for confirmation of a relationship between a prediction target and each explanatory variable may be provided as display information. For example, it is assumed that, for each product, an analysis of which advertising medium is effective in increasing sales of the product is performed. In this case, an advertising amount or the like for each advertising medium can be utilized as an explanatory variable in a predictive model that predicts sales of a product. Then, a degree at which each advertising medium contributes to sales of a product can be computed by generating a predictive model by use of a machine learning algorithm (e.g., heterogeneous mixture learning) being capable of quantifying a degree at which each explanatory variable contributes to prediction. Thus, for example, the analysis system 2000 provides, as display information, a screen or the like in which a relationship between sales of a product being a prediction target and an advertising medium being an explanatory variable (a degree at which each advertising medium contributes to sales, or the like) can be easily confirmed.

<<Regarding Timing of Generating Display Information>>

In such a case that a plurality of kinds of screens are handled as display information, a plurality of pieces of information differing from one another in timing to display may be handled as display information. In such a case, the plurality of pieces of information may be generated at once and collectively provided to a user, or may be generated at timings differing from one another and individually provided to a user. In the latter case, for example, the display information generation unit 2060 generates each piece of information at a timing when the information is to be displayed (i.e., a timing when a user needs the information).

For example, it is assumed that the analysis system 2000 includes the configuration illustrated in FIG. 4. In this case, first, the front-end server 30 generates a web page representing a screen (an initial screen of an analysis result) to be displayed first on a display apparatus of the user terminal 20 as the analysis result, and transmits the web page to the user terminal 20. Thereafter, when an operation of transition of the screen is performed by a user, a request based on the operation (a request by which identification information of a pressed button is indicated, or the like) is transmitted from the user terminal 20 to the front-end server 30. The front-end server 30 generates, based on the received request, a web page representing a new screen (i.e., a screen of a transition destination) to be provided to the user terminal 20, and transmits the generated web page to the user terminal 20.

<<Regarding View Definition Information 16>>

As described above, a screen output as display information may differ depending on a kind of algorithm utilized for generation of a predictive model. Accordingly, for example, information representing a kind of generation algorithm of a predictive model can be utilized as the view definition information 16. For example, the view definition information 16 indicates identification information (heterogeneous mixture learning, a RAPID time-series analysis, an SVM, or the like) of an AI engine utilized for generation of a predictive model, and an analysis type (a regression analysis or a determination analysis). In this case, for each pair of identification information of an AI engine and an analysis type, information (hereinafter, a display template) necessary for generation of display information in a case where the pair is indicated in the view definition information 16 is stored in a storage apparatus. The display template indicates a kind or structure of a diagram to be included in a screen, arrangement of each diagram, and the like. The display information generation unit 2060 reads, from the storage apparatus described above, a display template stored in association with identification information of an AI engine indicated by the view definition information 16 and an analysis type, and generates display information by use of the read display template.

Note that, as described above, identification information of an AI engine and an analysis type are also utilizable as the algorithm definition information 14. When information common to the algorithm definition information 14 and the view definition information 16 is utilized in this way, the pieces of common information do not need to be redundantly included in the template information 10, and it is preferred to handle the pieces of common information as both the algorithm definition information 14 and the view definition information 16.

Further, as described above, display information can be classified into a type particularly preferred for confirmation of accuracy of a predictive model (hereinafter, accuracy confirmation type), a type particularly preferred to confirm a relationship between a prediction target and each explanatory variable (hereinafter, relationship confirmation type), and the like. Thus, the view definition information 16 may further indicate a type for such a utilization purpose. In this case, for example, a display template is prepared in association with each combination of a type of utilization purpose, identification information of an AI engine, and an analysis type, and stored in a storage apparatus. The display information generation unit 2060 reads, from the storage apparatus, a display template being associated with a combination of a type of utilization purpose, identification information of an AI engine, and an analysis type indicated by the view definition information 16, and generates display information by use of the read display template.

The view definition information 16 may further include a parameter specifying information to be included in display information. For example, as described above, various evaluation indices such as an error rate, a root mean square error, or a mean square error can be adoptable as an evaluation index of a predictive model. Accordingly, which of the various evaluation indices is to be included in display information is specified in the view definition information 16. In this case, the display information generation unit 2060 generates display information in such a way that an evaluation index indicated in the view definition information 16 is included.

As another example of a parameter, an appellation of an evaluation index in display information can be cited. For example, it is assumed that an evaluation index referred to as an error rate is utilized as an index representing lowness of a credit rating of a model. In this case, in the view definition information 16, an error rate can be specified as an evaluation index to be included in display information, and “lowness of a credit rating of a model” can be specified as an appellation of an error rate.

<Specific Example of Template Information 10>

A specific example of the template information 10 is described below by use of a diagram. In each diagram, the template information 10 includes attributes being an analysis template name 302, an analysis template ID 304, a solution 306, an outline 308, an engine type 310, an objective variable 312, an output value 314, and an item definition 316. Note that, in the specific example illustrated in each diagram, the view definition information 16 is omitted. A specific example of the view definition information 16 is described later.

The analysis template name 302 indicates a name of the template information 10. Moreover, the analysis template ID 304 indicates identification information of the template information 10. The pieces of information are displayed in, for example, the search screen 50 that causes a user to select the template information 10 (see FIG. 6).

The solution 306 indicates a kind of solution provided by an analysis performed by the template information 10. For example, as described above, a kind of solution can be utilized for a search of the template information 10.

The outline 308 is information indicating an outline of an analysis performed by the template information 10. For example, the information can be displayed in the search screen 50 described above or the like, and thereby serve as a reference when a user selects the template information 10.

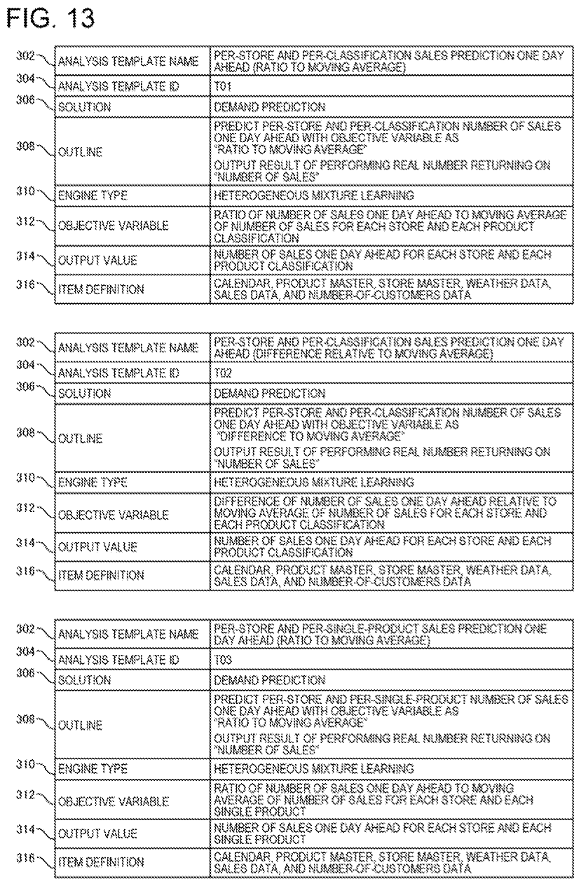

The engine type 310, the objective variable 312, and the output value 314 are pieces of information constituting the algorithm definition information 14. The engine type 310 indicates identification information of an AI engine utilized for generation of a predictive model. Note that, in FIG. 13 and the like, a name of an AI engine is indicated in the engine type 310 for easy understanding. However, the engine type 310 can be any information (an identification number or the like) with which an AI engine can be identified.

The objective variable 312 represents an objective variable of a predictive model to be generated. The objective variable 312 is a variable to be a target of minimizing an error when a predictive model is generated by learning using input data. On the other hand, the output value 314 indicates a value (a prediction result of a predictive model) output from the predictive model when the predictive model is utilized. For example, in a template T01 in FIG. 13, an objective variable is “a ratio of the number of sales one day ahead to a moving average of the number of sales for each store and each product classification”, and an output value is “the number of sales one day ahead for each store and each product classification”. Thus, when a predictive model is generated by use of input data, “a ratio of the number of sales one day ahead to a moving average of the number of sales” is computed for each store and each product classification, and learning is performed in such a way that the error is minimized. On the other hand, as a prediction result output from a predictive model, the number of sales one day ahead is output by utilizing a moving average and a ratio thereto.

Moreover, it can also be conceived to utilize, as an objective variable, logarithmic transformation of a value of a predetermined item, such as a “logarithm of the number of sales”. In this case, for example, it is preferred to use, as an output value, a value in which a logarithm is removed from an objective variable.

In this way, a value in which an objective variable is subjected to appropriate processing serves as a final output of a predictive model, whereby a value being useful for a user can be provided as a prediction result. Then, a method of such processing is previously defined by template information, and this allows even a user who is not an expert of a data analysis to easily perform an appropriate data analysis.

The item definition 316 is information equivalent to the item definition information 12. In other words, the item definition 316 represents an item of data utilized for a predictive model. Herein, in FIG. 13 and the like, the item definition 316 indicates a major item, and a sub item is omitted.

Note that, since a common major item may be utilized in a plurality of pieces of the template information 10, it is preferred to prepare association between a major item and a sub item apart from the template information 10. Consequently, association between a major item and a sub item can be managed apart from the template information 10, and labor for management thereof is lessened.

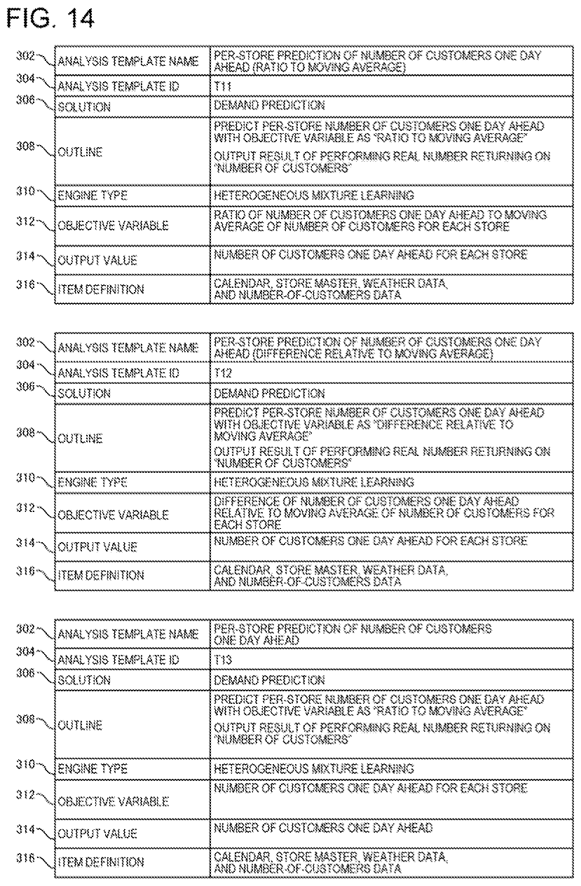

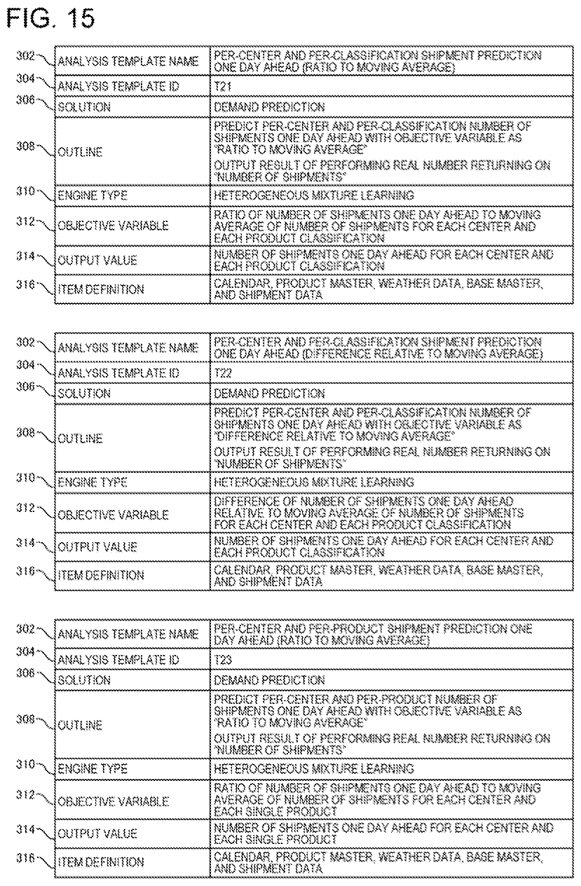

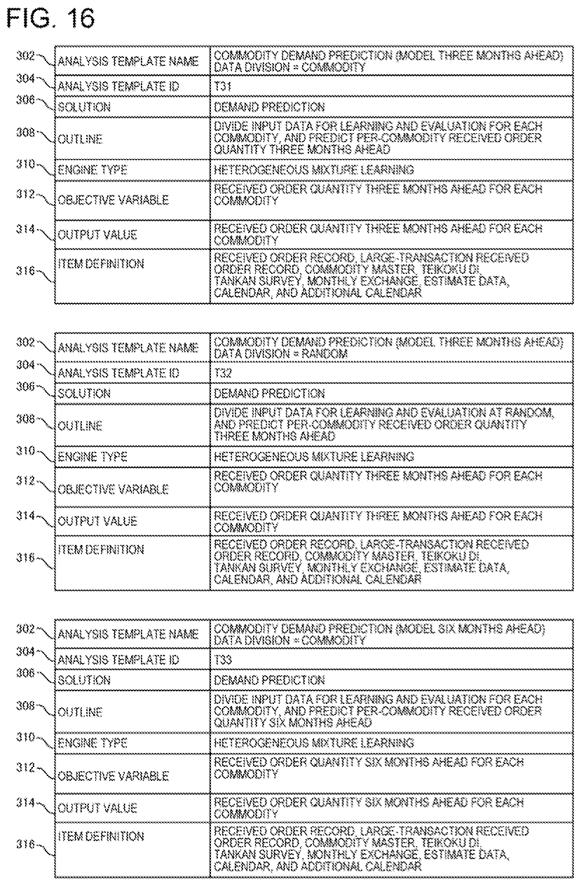

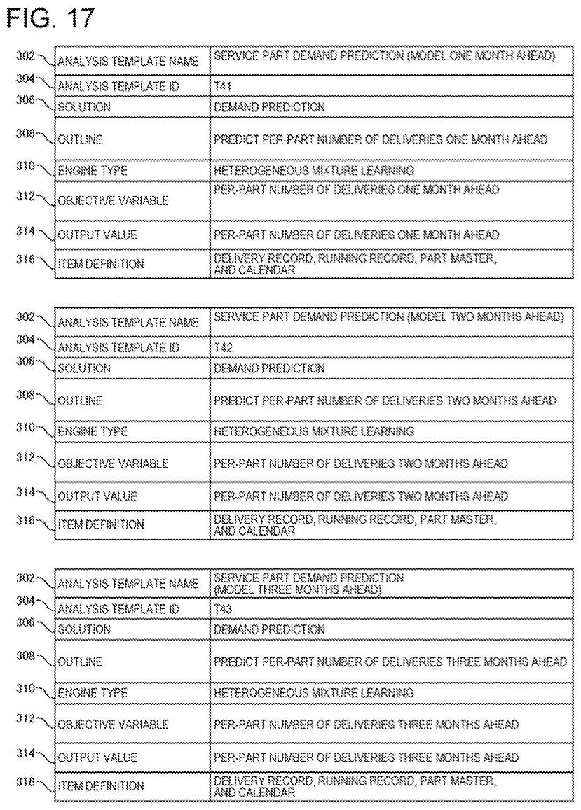

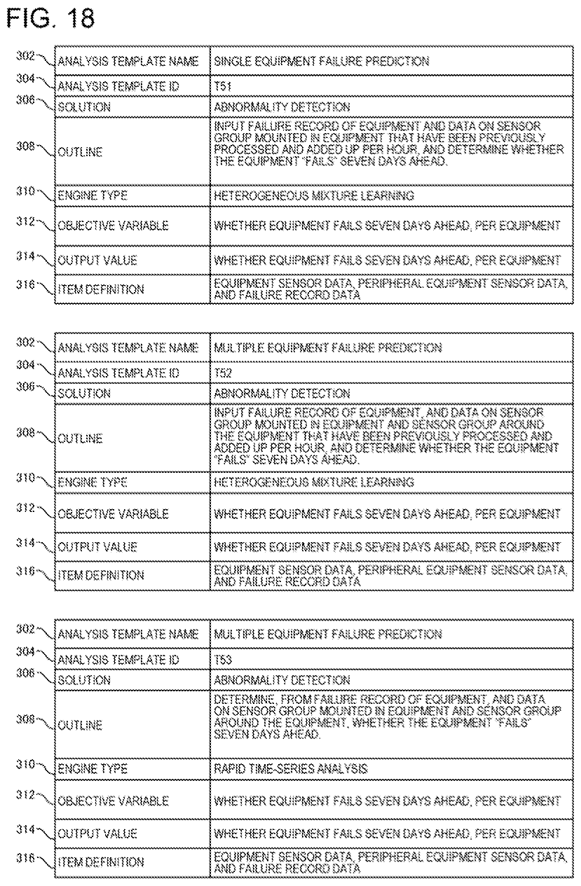

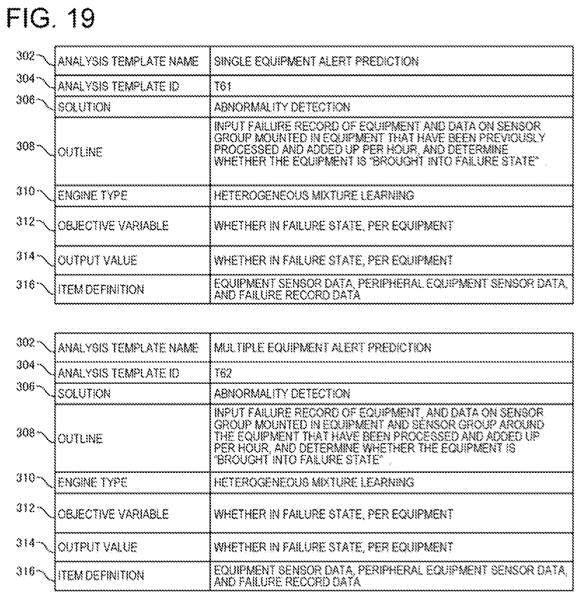

A specific example of the template information 10 is indicated below by utilizing FIGS. 13 to 19. Each of FIGS. 13 to 19 is a template regarding the following prediction.
FIG. 13: Prediction of the number of sales
FIG. 14: Prediction of the number of customers
FIG. 15: Prediction of the number of shipments
FIG. 16: Prediction of a received order quantity of a commodity
FIG. 17: Prediction of the number of deliveries of a service part
FIG. 18: Prediction of a failure
FIG. 19: Determination of a failure state or not

FIG. 13 is a diagram illustrating the template information 10 utilized for prediction of the number of sales. Pieces of template information T01, T02, and T03 differ from one another in the objective variable 312. Specifically, pieces of the template information T01 to T03 have objective variables “a ratio of the number of sales one day ahead to a moving average of the number of sales for each store and each product classification”, “a difference of the number of sales one day ahead relative to a moving average of the number of sales for each store and each product classification”, and “a ratio of the number of sales one day ahead to a moving average of the number of sales for each store and each single product”, respectively.

While pieces of the template information T01 and T02 have the common output value 314, the template information T03 differs in the output value 314 from the other two. Specifically, the output value 314 in each piece of the template information T01 and T02 is “the number of sales one day ahead for each store and each product classification”, whereas the output value 314 in the template information T03 is “the number of sales one day ahead for each store and each single product”.

On the other hand, a common point in all pieces of the template information 10 is that the solution 306 is “demand prediction”, the engine type 310 is “heterogeneous mixture learning”, and the item definition 316 is “a calendar, a product master, a store master, weather data, sales data, and data on the number of customers”.

FIG. 14 is a diagram illustrating the template information 10 utilized for prediction of the number of customers. Pieces of template information T11, T12, and T13 differ from one another in the objective variable 312. Specifically, pieces of the template information T11 to T13 have objective variables “a ratio of the number of customers one day ahead to a moving average of the number of customers for each store”, “a difference of the number of customers one day ahead relative to a moving average of the number of customers for each store”, and “the number of customers one day ahead for each store”, respectively.

On the other hand, a common point in all pieces of the template information 10 is that the output value 314 is “the number of customers one day ahead”, the solution 306 is “demand prediction”, the engine type 310 is “heterogeneous mixture learning”, and the item definition 316 is “a calendar, a store master, weather data, and data on the number of customers”.

FIG. 15 is a diagram illustrating the template information 10 utilized for prediction of the number of shipments. Pieces of template information T21, T22, and T23 differ from one another in the objective variable 312. Specifically, pieces of the template information T21 to T23 have objective variables “a ratio of the number of shipments one day ahead to a moving average of the number of shipments for each shipment center and each product classification”, “a difference of the number of shipments one day ahead relative to a moving average of the number of shipments for each shipment center and each product classification”, and “a ratio of the number of shipments one day ahead to a moving average of the number of shipments for each shipment center and each single product”, respectively.

While pieces of the template information T21 and T22 have the common output value 314, the template information T23 differs in the output value 314 from the other two. Specifically, the output value 314 in each of pieces of the template information T21 and T22 is “the number of shipments one day ahead for each shipment center and each product classification”, whereas the output value 314 in the template information T23 is “the number of shipments one day ahead for each shipment center and each single product”.

On the other hand, a common point in all pieces of the template information 10 is that the solution 306 is “demand prediction”, the engine type 310 is “heterogeneous mixture learning”, and the item definition 316 is “a calendar, a product master, weather data, a base master, and shipment data”.

FIG. 16 is a diagram illustrating the template information 10 utilized for prediction of a received order quantity of a commodity. In pieces of template information T31 and T32, each of the objective variable 312 and the output value 314 is “received order quantity three months ahead for each commodity”. On the other hand, in template information T33, each of the objective variable 312 and the output value 314 is “received order quantity six months ahead for each commodity”.

Moreover, in pieces of the template information T31 and T33, input data are divided for learning and evaluation for each commodity, and generation and evaluation of a predictive model are performed, as described in the outline 308. On the other hand, in the template information T32, input data are divided for learning and evaluation at random, and generation and evaluation of a predictive model are performed, as described in the outline 308. A criterion of such data division is included in, for example, the algorithm definition information 14 as a hyperparameter supplied to an AI engine.

On the other hand, a common point in all pieces of the template information 10 is that the solution 306 is “demand prediction”, the engine type 310 is “heterogeneous mixture learning”, and the item definition 316 is “a received order record, a large-transaction received order record, a commodity master, a Teikoku diffusion index (DI), Tankan survey, monthly exchange, estimate data, a calendar, and an additional calendar”.

FIG. 17 is a diagram illustrating the template information 10 utilized for prediction of the number of deliveries of a service part. Pieces of template information T41 to T43 differ from one another in the objective variable 312. Specifically, pieces of the template information T41 to T43 have objective variables “the number of deliveries one month ahead on a part basis”, “the number of deliveries two months ahead on a part basis”, and “the number of deliveries three months ahead on a part basis”, respectively. The same also applies to the output value 314.

On the other hand, a common point in all pieces of the template information 10 is that the solution 306 is “demand prediction”, the engine type 310 is “heterogeneous mixture learning”, and the item definition 316 is “a delivery record, a running record, a part master, and a calendar”.

FIG. 18 is a diagram illustrating the template information 10 utilized for prediction of a failure of equipment. In pieces of template information T51 to T53, each of the objective variable 312 and the output value 314 is “whether equipment fails seven days ahead, for each piece of equipment”. Note that, while each of predictive models generated by the template information 10 illustrated in FIGS. 13 to 17 is a regression model, a predictive model generated by the template information 10 illustrated in each of FIG. 18 and FIG. 19 described later becomes a determination model.

Pieces of the template information T51 to T53 differ in learning algorithm of a predictive model. First, the engine type 310 is heterogeneous mixture learning in the template information T51 and T52, whereas the engine type 310 is a RAPID time-series analysis in the template information T53.

In addition to the engine type 310, there is also a difference regarding preprocessing to which input data are added. In the template information T51, preprocessing of processing and adding up per hour is performed on a failure record of equipment, and data on a sensor group mounted in equipment. In the template information T52, preprocessing of processing and adding up per hour is performed on a failure record of equipment, data on a sensor group mounted in equipment, and data on a sensor group around the equipment. In the template information T53, such preprocessing of processing and adding up per hour is not performed. Definition of such preprocessing is included in the algorithm definition information 14.

On the other hand, a common point in all pieces of the template information 10 is that the solution 306 is “abnormality sensing”, and the item definition 316 is “equipment sensor data, peripheral equipment sensor data, and failure record data”.

FIG. 19 is a diagram illustrating the template information 10 utilized for determination of a failure state or not. In pieces of template information T61 and T62, each of the objective variable 312 and the output value 314 is “whether equipment is brought into a failure state, for each piece of equipment”.

The template information T61 and T62 differ in preprocessing on input data. In the template information T61, preprocessing of processing and adding up per hour is performed on a failure record of equipment, and data on a sensor group mounted in equipment. In the template information T62, preprocessing of processing and adding up per hour is performed on a failure record of equipment, data on a sensor group mounted in equipment, and data on a sensor group around the equipment.

On the other hand, a common point in both pieces of the template information 10 is that the engine type 310 is “heterogeneous mixture learning”, the solution 306 is “abnormality sensing”, and the item definition 316 is “equipment sensor data, peripheral equipment sensor data, and failure record data”.

<<Specific Example of View Definition Information 16>>

In relation to a specific example of the template information 10 described above, several specific examples of the view definition information 16 are described. For example, the template information 10 can include, as the view definition information 16, information such as “an analysis type”, “a utilization purpose type”, “whether to utilize an evaluation index”, and “a name of an evaluation index”. Moreover, the engine type 310 can also be utilized as the view definition information 16. Specifically, a display template is prepared in association of a set of an analysis type, an engine type, and a utilization purpose type.

For example, it is preferred to add the following information to the template information T01 in FIG. 13, as the view definition information 16.
Analysis type: regression
Utilization purpose type: accuracy confirmation
Whether to utilize evaluation index: all evaluation indices are utilized
Name of evaluation index: no change

Herein, “whether to utilize evaluation index: all evaluation indices are utilized” means that all evaluation indices prepared in association with an analysis type are included in display information. For example, in this case, since an analysis type is a regression analysis, all evaluation indices (precision, recall, an F-value, and the like) prepared as evaluation indices for a regression analysis are included in display information. Moreover, “name of evaluation index: no change” means that a name of an evaluation index is used as an appellation of an evaluation index without change (e.g., an error rate is displayed as “error rate” without change.

Additionally, for example, it is preferred to add the following information to the template information T51 in FIG. 18, as the view definition information 16.
Analysis type: determination
Utilization purpose type: accuracy confirmation
Whether to utilize evaluation index: all evaluation indices are utilized
Name of evaluation index: no change

<Customization of Template Information 10 by User>

A user may be allowed to customize some of contents of the template information 10. In other words, a user can select favorite one from pieces of the previously registered template information 10 and utilize the selected template information 10 without change, or can customize and utilize part of the selected template information 10.

Customization of the template information 10 may be performed when an analysis is executed, or may be previously performed prior to an analysis. In the latter case, it is preferable that the analysis system 2000 registers the customized template information 10 as the new template information 10 (stores the customized template information 10 in the template storage apparatus 60). In this case, when a user performs specification of the template information 10 (S102), the template information 10 customized by the user also becomes selectable in a similar way to the existing template information 10. Thus, the user can specify the previously customized and registered template information 10 at an analysis, and execute an analysis utilizing the template information 10.

Note that, it is preferred that, even when customization of the template information 10 is performed at execution of an analysis, the template information 10 after the customization can be registered in the analysis system 2000. Consequently, the customized template information 10 becomes utilizable in and after a next analysis.

While the example embodiments of the present invention have been described above with reference to the drawings, the example embodiments are exemplifications of the present invention, and a combination of the example embodiments described above and various configurations other than the configuration described above can also be adopted.

Some or all of the above-described example embodiments can also be described as, but are not limited to, the following supplementary notes.
1. An analysis system including:
   an input acceptance unit that accepts input specifying one of a plurality of pieces of template information,
   the template information including item definition information determining an item of each piece of input data utilized for generation of a predictive model, algorithm definition information determining a generation algorithm of a predictive model, and view definition information determining a display aspect of information relating to a predictive model;
   a predictive model generation unit that acquires, regarding each item determined by the item definition information of the specified template information, input data being associated with the item, processes the acquired input data, based on an algorithm determined by the algorithm definition information of the specified template information, and thereby generates a predictive model; and
   a display information generation unit that generates display information representing information relating to the generated predictive model, in a display aspect determined by the view definition information of the specified template information.
2. The analysis system according to supplementary note 1, wherein the input acceptance unit outputs display representing each item determined by the item definition information, and accepts, regarding each of the items, specification of input data being associated with the item.
3. The analysis system according to supplementary note 2, wherein the item definition information indicates one or more major items,
   a plurality of sub items are associated with the major item, and
   the input acceptance unit
      accepts specification of input data being associated with the major item, and further accepts input specifying an association relation between a plurality of sub items being associated with the major item and a plurality of sub items included in the input data.
4. The analysis system according to any one of supplementary notes 1 to 3, wherein the algorithm definition information includes a machine learning program utilized for generation of the predictive model, or includes identification information of the machine learning program.
5. The analysis system according to supplementary note 4, wherein the algorithm definition information includes preprocessing of converting a value included in the input data into a format required by the machine learning program.
6. The analysis system according to supplementary note 4, wherein the algorithm definition information includes preprocessing of converting a value included in the input data into a value improving accuracy of a predictive model generated by the machine learning program.
7. The analysis system according to any one of supplementary notes 1 to 6, wherein
   a display template indicating information necessary for generation of the display information is determined in association with a combination of identification information of an algorithm used for generation of the predictive model, and a type of analysis using the predictive model,
   the view definition information indicates identification information of an algorithm and a type of analysis, and
   the display information generation unit acquires the display template being associated with a combination of identification information of an algorithm and a type of analysis indicated by the view definition information of the specified template information, and generates the display information by utilizing the display template.
8. The analysis system according to supplementary note 7, wherein
   the display template is determined in association with a combination of identification information of an algorithm, a type of analysis, and a type of utilization purpose of the display information,
   the view definition information further indicates a utilization purpose of the display information, and
   the display information generation unit acquires the display template being associated with a combination of identification information of an algorithm, a type of analysis, and a utilization purpose of the display information indicated by the view definition information of the specified template information.
9. An apparatus including:
   an input acceptance unit that accepts input specifying one of a plurality of pieces of template information,
   the template information including item definition information determining an item of each piece of input data utilized for generation of a predictive model, algorithm definition information determining a generation algorithm of a predictive model, and view definition information determining a display aspect of information relating to a predictive model:
   by the input acceptance unit, further accepting, regarding each item determined by the item definition information of the specified template information, specification of input data being associated with the item; and
   a display information generation unit that generates display information representing information relating to a predictive model, in a display aspect determined by the view definition information of the specified template information, wherein
   the predictive model is generated by processing the specified input data, based on an algorithm determined by the algorithm definition information of the specified template information.
10. The apparatus according to supplementary note 9, wherein the input acceptance unit outputs display representing each item determined by the item definition information, and accepts, regarding each of the items, specification of input data being associated with the item.
11. The apparatus according to supplementary note 10, wherein
   the item definition information indicates one or more major items,
   a plurality of sub items are associated with the major item, and
   the input acceptance unit
      accepts specification of input data being associated with the major item, and further accepts input specifying an association relation between a plurality of sub items being associated with the major item and a plurality of sub items included in the input data.
12. The apparatus according to any one of supplementary notes 9 to 11, wherein the algorithm definition information includes a machine learning program utilized for generation of the predictive model, or includes identification information of the machine learning program.
13. The apparatus according to supplementary note 12, wherein the algorithm definition information includes preprocessing of converting a value included in the input data into a format required by the machine learning program.
14. The apparatus according to supplementary note 12, wherein the algorithm definition information includes preprocessing of converting a value included in the input data into a value improving accuracy of a predictive model generated by the machine learning program.
15. The apparatus according to any one of supplementary notes 9 to 14, wherein
   a display template indicating information necessary for generation of the display information is determined in association with a combination of identification information of an algorithm used for generation of the predictive model, and a type of analysis using the predictive model,
   the view definition information indicates identification information of an algorithm and a type of analysis, and
   the display information generation unit acquires the display template being associated with a combination of identification information of an algorithm and a type of analysis indicated by the view definition information of the specified template information, and generates the display information by utilizing the display template.
16. The apparatus according to supplementary note 15, wherein
   the display template is determined in association with a combination of identification information of an algorithm, a type of analysis, and a type of utilization purpose of the display information,
   the view definition information further indicates a utilization purpose of the display information, and
   the display information generation unit acquires the display template being associated with a combination of identification information of an algorithm, a type of analysis, and a utilization purpose of the display information indicated by the view definition information of the specified template information.
17. A control method executed by a computer, including:
   an input acceptance step of accepting input specifying one of a plurality of pieces of template information,
   the template information including item definition information determining an item of each piece of input data utilized for generation of a predictive model, algorithm definition information determining a generation algorithm of a predictive model, and view definition information determining a display aspect of information relating to a predictive model;
   a predictive model generation step of acquiring, regarding each item determined by the item definition information of the specified template information, input data being associated with the item, processing the acquired input data, based on an algorithm determined by the algorithm definition information of the specified template information, and thereby generating a predictive model; and
   a display information generation step of generating display information representing information relating to the generated predictive model, in a display aspect determined by the view definition information of the specified template information.
18. The control method according to supplementary note 17, further including, in the input acceptance step, outputting display representing each item determined by the item definition information, and accepting, regarding each of the items, specification of input data being associated with the item.
19. The control method according to supplementary note 18, wherein
   the item definition information indicates one or more major items,
   a plurality of sub items are associated with the major item, and
   the control method further including, in the input acceptance step,
      accepting specification of input data being associated with the major item, and further accepting input specifying an association relation between a plurality of sub items being associated with the major item and a plurality of sub items included in the input data.
20. The control method according to any one of supplementary notes 17 to 19, wherein the algorithm definition information includes a machine learning program utilized for generation of the predictive model, or includes identification information of the machine learning program.
21. The control method according to supplementary note 20, wherein the algorithm definition information includes preprocessing of converting a value included in the input data into a format required by the machine learning program.
22. The control method according to supplementary note 20, wherein the algorithm definition information includes preprocessing of converting a value included in the input data into a value improving accuracy of a predictive model generated by the machine learning program.
23. The control method according to any one of supplementary notes 17 to 22, wherein
   a display template indicating information necessary for generation of the display information is determined in association with a combination of identification information of an algorithm used for generation of the predictive model, and a type of analysis using the predictive model,
   the view definition information indicates identification information of an algorithm and a type of analysis, and
   the control method further including, in the display information generation step, acquiring the display template being associated with a combination of identification information of an algorithm and a type of analysis indicated by the view definition information of the specified template information, and generating the display information by utilizing the display template.
24. The control method according to supplementary note 23, wherein
   the display template is determined in association with a combination of identification information of an algorithm, a type of analysis, and a type of utilization purpose of the display information,
   the view definition information further indicates a utilization purpose of the display information, and
   the control method further including, in the display information generation step, acquiring the display template being associated with a combination of identification information of an algorithm, a type of analysis, and a utilization purpose of the display information indicated by the view definition information of the specified template information.
25. A control method executed by a computer, including:
   an input acceptance step of accepting input specifying one of a plurality of pieces of template information,
   the template information including item definition information determining an item of each piece of input data utilized for generation of a predictive model, algorithm definition information determining a generation algorithm of a predictive model, and view definition information determining a display aspect of information relating to a predictive model;
   in the input acceptance step, further accepting, regarding each item determined by the item definition information of the specified template information, specification of input data being associated with the item; and
   a display information generation step of generating display information representing information relating to a predictive model, in a display aspect determined by the view definition information of the specified template information, wherein
   the predictive model is generated by processing the specified input data, based on an algorithm determined by the algorithm definition information of the specified template information.
26. The control method according to supplementary note 25, further including, in the input acceptance step, outputting display representing each item determined by the item definition information, and accepting, regarding each of the items, specification of input data being associated with the item.
27. The control method according to supplementary note 26, wherein
   the item definition information indicates one or more major items,
   a plurality of sub items are associated with the major item, and
   the control method further including, in the input acceptance step,
      accepting specification of input data being associated with the major item, and further accepting input specifying an association relation between a plurality of sub items being associated with the major item and a plurality of sub items included in the input data.
28. The control method according to any one of supplementary notes 25 to 27, wherein the algorithm definition information includes a machine learning program utilized for generation of the predictive model, or includes identification information of the machine learning program.
29. The control method according to supplementary note 28, wherein the algorithm definition information includes preprocessing of converting a value included in the input data into a format required by the machine learning program.
30. The control method according to supplementary note 28, wherein the algorithm definition information includes preprocessing of converting a value included in the input data into a value improving accuracy of a predictive model generated by the machine learning program.
31. The control method according to any one of supplementary notes 25 to 30, wherein
   a display template indicating information necessary for generation of the display information is determined in association with a combination of identification information of an algorithm used for generation of the predictive model, and a type of analysis using the predictive model,
   the view definition information indicates identification information of an algorithm and a type of analysis, and
   the control method further including, in the display information generation step, acquiring the display template being associated with a combination of identification information of an algorithm and a type of analysis indicated by the view definition information of the specified template information, and generating the display information by utilizing the display template.
32. The control method according to supplementary note 31, wherein
   the display template is determined in association with a combination of identification information of an algorithm, a type of analysis, and a type of utilization purpose of the display information,
   the view definition information further indicates a utilization purpose of the display information, and
   the control method further including, in the display information generation step, acquiring the display template being associated with a combination of identification information of an algorithm, a type of analysis, and a utilization purpose of the display information indicated by the view definition information of the specified template information.
33. A program causing a computer to execute each step of the control method according to any one of supplementary notes 17 to 32.

This application is based upon and claims the benefit of priority from Japanese patent application No. 2019-152096, filed on Aug. 22, 2019, the disclosure of which is incorporated herein in its entirety by reference.

### REFERENCE SIGNS LIST

10 Template information
12 Item definition information
14 Algorithm definition information
16 View definition information
20 User terminal
30 Front-end server
40 Back-end server
50 Search screen
52 Identification information specification area
54 Name specification area
56 Search button
58 Search result display area
60 Template storage apparatus
70 Screen
80 Scatter diagram screen
82 Pop-up window
90 List screen
110 Scatter diagram screen
120 List screen
130 Detail screen
131 Evaluation index area
132 Explanatory variable list area
134 Graph area
135 Gate tree area
136 Prediction expression area
302 Analysis template name
304 Analysis template ID
306 Solution
308 Outline
310 Engine type
312 Objective variable
314 Output value
316 Item definition
1000 Computer
1020 Bus
1040 Processor
1060 Memory
1080 Storage device
1100 Input-output interface
1120 Network interface
2000 Analysis system
2020 Input acceptance unit
2040 Predictive model generation unit
2060 Display information generation unit

What is claimed is:

1. An analysis system comprising:
an input acceptance unit that accepts input specifying one of a plurality of pieces of template information,
the template information including item definition information determining an item of each piece of input data utilized for generation of a predictive model, algorithm definition information determining a generation algorithm of a predictive model, and view definition information determining a display aspect of information relating to a predictive model;
a predictive model generation unit that acquires, regarding each item determined by the item definition information of the specified template information, input data being associated with the item, processes the acquired input data, based on an algorithm determined by the algorithm definition information of the specified template information, and thereby generates a predictive model; and
a display information generation unit that generates display information representing information relating to the generated predictive model, in a display aspect determined by the view definition information of the specified template information.

2. The analysis system according to claim 1, wherein
the input acceptance unit outputs display representing each item determined by the item definition information, and accepts, regarding each of the items, specification of input data being associated with the item.

3. The analysis system according to claim 2, wherein
the item definition information indicates one or more major items,
a plurality of sub items are associated with the major item, and
the input acceptance unit accepts specification of input data being associated with the major item, and further accepts input specifying an association relation between a plurality of sub items being associated with the major item and a plurality of sub items included in the input data.

4. The analysis system according to claim 1, wherein
the algorithm definition information includes a machine learning program utilized for generation of the predictive model, or includes identification information of the machine learning program.

5. The analysis system according to claim 4, wherein
the algorithm definition information includes preprocessing of converting a value included in the input data into a format required by the machine learning program.

6. The analysis system according to claim 4, wherein
the algorithm definition information includes preprocessing of converting a value included in the input data into a value improving accuracy of a predictive model generated by the machine learning program.

7. The analysis system according to claim 1, wherein
a display template indicating information necessary for generation of the display information is determined in association with a combination of identification information of an algorithm used for generation of the predictive model, and a type of analysis using the predictive model,
the view definition information indicates identification information of an algorithm and a type of analysis, and
the display information generation unit acquires the display template being associated with a combination of identification information of an algorithm and a type of analysis indicated by the view definition information of the specified template information, and generates the display information by utilizing the display template.

8. The analysis system according to claim 7, wherein
the display template is determined in association with a combination of identification information of an algorithm, a type of analysis, and a type of utilization purpose of the display information,
the view definition information further indicates a utilization purpose of the display information, and
the display information generation unit acquires the display template being associated with a combination of identification information of an algorithm, a type of analysis, and a utilization purpose of the display information indicated by the view definition information of the specified template information.

9. An apparatus comprising:
an input acceptance unit that accepts input specifying one of a plurality of pieces of template information,
the template information including item definition information determining an item of each piece of input data utilized for generation of a predictive model, algorithm definition information determining a generation algorithm of a predictive model, and view definition information determining a display aspect of information relating to a predictive model;
by the input acceptance unit, further accepting, regarding each item determined by the item definition information of the specified template information, specification of input data being associated with the item; and
a display information generation unit that generates display information representing information relating to a predictive model, in a display aspect determined by the view definition information of the specified template information, wherein
the predictive model is generated by processing the specified input data, based on an algorithm determined by the algorithm definition information of the specified template information.

10. The apparatus according to claim 9, wherein
the input acceptance unit outputs display representing each item determined by the item definition information, and accepts, regarding each of the items, specification of input data being associated with the item.

11. The apparatus according to claim 10, wherein
the item definition information indicates one or more major items,
a plurality of sub items are associated with the major item, and
the input acceptance unit accepts specification of input data being associated with the major item, and further accepts input specifying an association relation between a plurality of sub items being associated with the major item and a plurality of sub items included in the input data.

12. The apparatus according to claim 9, wherein
the algorithm definition information includes a machine learning program utilized for generation of the predictive model, or includes identification information of the machine learning program.

13. The apparatus according to claim 12, wherein
the algorithm definition information includes preprocessing of converting a value included in the input data into a format required by the machine learning program.

14. The apparatus according to claim 12, wherein
the algorithm definition information includes preprocessing of converting a value included in the input data into a value improving accuracy of a predictive model generated by the machine learning program.

15. The apparatus according to claim 9, wherein
a display template indicating information necessary for generation of the display information is determined in association with a combination of identification information of an algorithm used for generation of the predictive model, and a type of analysis using the predictive model,
the view definition information indicates identification information of an algorithm and a type of analysis, and
the display information generation unit acquires the display template being associated with a combination of identification information of an algorithm and a type of analysis indicated by the view definition information of the specified template information, and generates the display information by utilizing the display template.

16. The apparatus according to claim 15, wherein
the display template is determined in association with a combination of identification information of an algorithm, a type of analysis, and a type of utilization purpose of the display information,
the view definition information further indicates a utilization purpose of the display information, and
the display information generation unit acquires the display template being associated with a combination of identification information of an algorithm, a type of analysis, and a utilization purpose of the display information indicated by the view definition information of the specified template information.

17. A control method executed by a computer, comprising:
an input acceptance step of accepting input specifying one of a plurality of pieces of template information,
the template information including item definition information determining an item of each piece of input data utilized for generation of a predictive model, algorithm definition information determining a generation algorithm of a predictive model, and view definition information determining a display aspect of information relating to a predictive model;
a predictive model generation step of acquiring, regarding each item determined by the item definition information of the specified template information, input data being associated with the item, processing the acquired input data, based on an algorithm determined by the algorithm definition information of the specified template information, and thereby generating a predictive model; and
a display information generation step of generating display information representing information relating to the generated predictive model, in a display aspect determined by the view definition information of the specified template information.

18. The control method according to claim 17, further comprising,
in the input acceptance step, outputting display representing each item determined by the item definition information, and accepting, regarding each of the items, specification of input data being associated with the item.

19. The control method according to claim 18, wherein
the item definition information indicates one or more major items,
a plurality of sub items are associated with the major item, and
the control method further comprising,
in the input acceptance step, accepting specification of input data being associated with the major item, and further accepting input specifying an association relation between a plurality of sub items being associated with the major item and a plurality of sub items included in the input data.

20-32. (canceled)

33. A non-transitory computer readable medium having recorded thereon a program causing a computer to execute each step of the control method according to claim 19.
